(19) United States
(12) Patent Application Publication
(10) Pub. No.: US 2026/0134869 A1
(43) Pub. Date: May 14, 2026

(54) CONVERSION METHOD OF SPEECH DATA INTO TEXT

(71) Applicant: Toyota Jidosha Kabushiki Kaisha, Toyota-shi (JP)

(72) Inventor: Hirofumi MORISHITA, Anjo-shi (JP)

(73) Assignee: Toyota Jidosha Kabushiki Kaisha, Toyota-shi (JP)

(21) Appl. No.: 19/373,930

(22) Filed: Oct. 30, 2025

(30) Foreign Application Priority Data
Nov. 12, 2024 (JP) 2024-197755

(51) Int. Cl. G10L 15/26; G10L 15/00; G10L 15/02

(52) U.S. Cl. CPC G10L 15/26; G10L 15/005; G10L 15/02

(57) ABSTRACT

A conversion method of speech data into text, executed by an information processing device, includes acquiring speech data, detecting a particular expression in the speech data, and feature information related to speaking of the particular expression, and outputting text information related to the speech data in a manner that enables distinguishing of a portion regarding which standard language conversion processing is not performable, when the standard language conversion processing to convert the particular expression into corresponding standard language based on the particular expression and the feature information that are detected is not performable.

### CROSS-REFERENCE TO RELATED APPLICATION

This application claims priority to Japanese Patent Application No. 2024-197755 filed on November 12, 2024. The disclosure of the above-identified application, including the specification, drawings, and claims, is incorporated by reference herein in its entirety.

### BACKGROUND

### 1. Technical Field

The present disclosure relates to a conversion method of speech data into text.

### 2. Description of Related Art

Conventionally, there is known technology for analyzing contents of business negotiations. For example, Japanese Unexamined Patent Application Publication No. 2019-28910 (JP 2019-28910 A) discloses a dialogue analysis system that checks whether a sales representative in business negotiations with a customer communicates matters that should be communicated, and does not state matters that should not be stated. Also, for example, Horimoto et al., "Toyama Dialect Recognition and Conversion to Standard Japanese via Deep Learning," The 38th Annual Conference of the Japanese Society for Artificial Intelligence (2024), discloses speech recognition technology for the Toyama dialect.

### SUMMARY

Although JP 2019-28910 A discloses technology for analyzing the contents of business negotiations using machine learning, neither JP 2019-28910 A nor Horimoto et al., "Toyama Dialect Recognition and Conversion to Standard Japanese via Deep Learning," The 38th Annual Conference of the Japanese Society for Artificial Intelligence (2024), make any mention of transcribing speech during business negotiations or the like, i.e., conversion technology for converting speech data into text. There was room for improvement in speech transcription technology, and in particular, for speech data that includes dialects, accents, and other non-standard language. On the other hand, improving conversion technology of speech data into text is preferable, for the purpose of analyzing the contents of business negotiations and so forth, providing feedback, and so forth. As such, there is room for improvement in the conversion technology for converting speech data into text during business negotiations and so forth.

In view of the above circumstances, an object of the present disclosure is to improve conversion technology of speech data into text.

A conversion method of speech data into text,according to an embodiment of the present disclosure, is

a conversion method of speech data into text, executed by an information processing device, the conversion method including

acquiring speech data,

detecting a particular expression in the speech data, and feature information related to speaking of the particular expression, and

outputting text information related to the speech data in a manner that enables distinguishing of a portion regarding which standard language conversion processing is not performable, when the standard language conversion processing to convert the particular expression into corresponding standard language based on the particular expression and the feature information that are detected is not performable.

According to an embodiment of the present disclosure, improved conversion technology of speech data to text is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment; and

FIG. 2 is a flowchart showing operations of an information processing device.

### DETAILED DESCRIPTION OF EMBODIMENTS

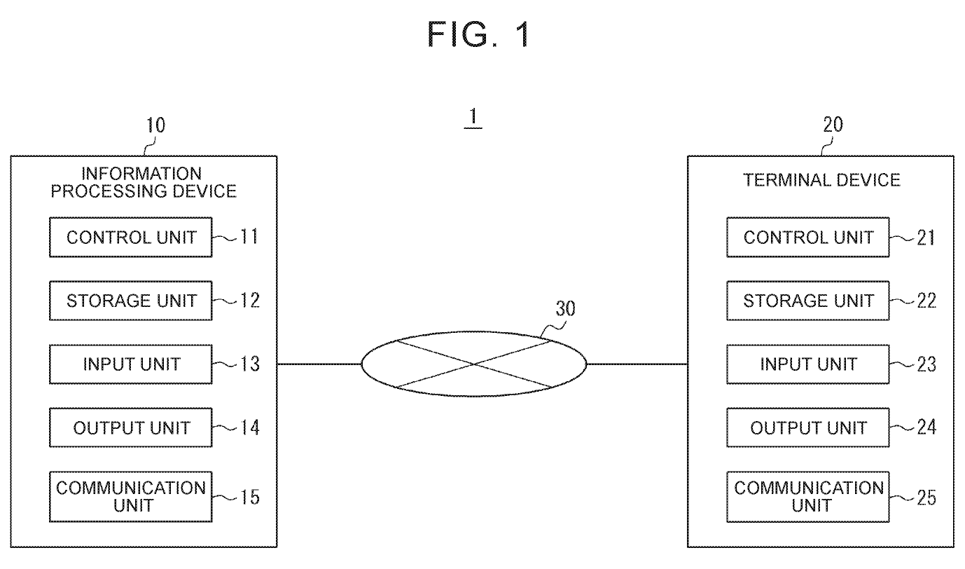

An embodiment of the present disclosure will be described below. An outline and a configuration of a system 1 according to the present embodiment will be described with reference to FIG. 1. The system 1 according to the present embodiment includes an information processing device 10 and a terminal device 20. The information processing device 10 is, for example, a server device that is installed in a data center or the like. The terminal device 20 is any device that is used by a user. These devices are communicatively connected via a network 30 such as the Internet or the like. Note that while FIG. 1 illustrates one each of the information processing device 10 and the terminal device 20, the system 1 may include a plurality of such devices.

First, an overview of the conversion method of speech data into text according to the present embodiment will be described, and details will be described later. Note that speech data may be data of speech during business negotiations, for example. In the present embodiment, business negotiations are, for example, business negotiations regarding vehicle sales, in which the offerings of the business negotiations is a vehicle, but are not limited thereto. For example, the business negotiations may be meetings that are aimed at concluding various types of contracts, such as buying or selling real estate, signing an insurance contract, selling financial products, and so forth. Also, the offerings related to the business negotiations in the present embodiment may be products, services, digital content, licenses, data/information, financial products, real estate, intangible assets, other tradable rights, and so forth.

The information processing device 10 acquires speech data. The information processing device 10 also detects particular expressions in the speech data, and feature information related to speaking of the particular expressions. When unable to perform standard language conversion processing to convert a particular expression into the corresponding standard language based on the particular expression and the feature information that are detected, the information processing device 10 outputs text information relating to the speech data in a manner that enables distinguishing of the portion regarding which standard language conversion processing was unsuccessful.

Thus, according to the present embodiment, the information processing device 10 detects particular expressions in the speech data and feature information related to speaking of the particular expressions, and when standard language conversion processing is unsuccessful, outputs text information related to the speech data in a manner that enables distinguishing of the portion regarding which standard language conversion processing was unsuccessful. Accordingly, when a particular expression is inconvertible, text information is output in a manner that makes the relevant portion distinguishable, thereby improving text conversion technology for speech data, in that unsuccessful conversion into standard language can be readily comprehended.

Next, each of the configurations of the information processing device 10 and the terminal device 20 will be described in detail. As illustrated in FIG. 1, the information processing device 10 includes a control unit 11, a storage unit 12, an input unit 13, an output unit 14, and a communication unit 15. The control unit 11 includes at least one processor. The processor may be a general-purpose processor such as a central processing unit (CPU), or a dedicated processor that is specialized for specific processing. The control unit 11 executes processing related to the operation of the information processing device 10, while controlling each component of the information processing device 10. The storage unit 12 includes at least one semiconductor memory or the like. The semiconductor memory is, for example, random access memory (RAM) or read-only memory (ROM). The storage unit 12 serves as, for example, a main storage device, an auxiliary storage device, or the like. The storage unit 12 stores data that is used for the operations of the information processing device 10 and data that is acquired through the operations of the information processing device 10. The input unit 13 includes at least one input interface. The input interface may be, for example, a physical key, a touchscreen display, an audio sensor that accepts speech input, a camera that accepts gesture input, or the like. The input unit 13 accepts input operations for inputting data that is used for operations of the information processing device 10. The output unit 14 includes at least one output interface. The output interface is, for example, a display that outputs information as video, or a speaker that outputs information as audio, or the like. The output unit 14 outputs data that is obtained by the operations of the information processing device 10. The communication unit 15 includes at least one external communication interface. The communication interface may be an interface for either wired communication or wireless communication. In the case of wired communication, the communication interface is, for example, a local area network (LAN) interface or a universal serial bus (USB) interface. In the case of wireless communication, the communication interface is, for example, an interface that is compatible with mobile communication standards such as 5G or the like, or an interface that is compatible with short-range wireless communication. The communication unit 15 receives data that is used in the operations of the information processing device 10 and also transmits data obtained through the operations of the information processing device 10.

Also, as illustrated in FIG. 1, the terminal device 20 includes a control unit 21, a storage unit 22, an input unit 23, an output unit 24, and a communication unit 25. The control unit 21 includes at least one processor. The processor may be a general-purpose processor such as a CPU or the like, or a dedicated processor that is specialized for specific processing. The control unit 21 executes processing related to the operations of the terminal device 20 while controlling each unit of the terminal device 20. The storage unit 22 includes at least one semiconductor memory or the like. The semiconductor memory is, for example, RAM or ROM. The storage unit 22 functions as, for example, a main storage device, an auxiliary storage device, or the like. The storage unit 22 stores data that is used for the operations of the terminal device 20 and data that is acquired through the operations of the terminal device 20. The input unit 23 includes at least one input interface. The input interface may be, for example, a physical key, a touchscreen display, an audio sensor that accepts speech input, a camera that accepts gesture input, or the like. The input unit 23 accepts operations of inputting data that is used for the operations of the terminal device 20. The output unit 24 includes at least one output interface. The output interface is, for example, a display that outputs information as video, or a speaker that outputs information as audio, or the like. The output unit 24 outputs data that is acquired through the operations of the terminal device 20. The communication unit 25 includes at least one interface for external communication. The communication interface may be an interface for either wired communication or wireless communication. In the case of wired communication, the communication interface is, for example, a LAN interface or a USB interface. In the case of wireless communication, the communication interface is, for example, an interface that is compatible with mobile communication standards such as 5G or the like, or an interface that is compatible with short-range wireless communication. The communication unit 25 receives the data that is used for the operations of the terminal device 20, and also transmits the data that is obtained by the operations of the terminal device 20.

Functions of the information processing device 10 or the terminal device 20 are realized by executing a program according to the present embodiment in a processor corresponding to the control unit 11 or the control unit 21. That is to say, the functions of the information processing device 10 or the terminal device 20 are realized by software. The program causes a computer to execute the operations of the information processing device 10 or the terminal device 20, thereby causing the computer to function as the information processing device 10 or the terminal device 20. That is to say, the computer functions as the information processing device 10 or the terminal device 20 by executing the operations of the information processing device 10 or the terminal device 20 in accordance with the program. In the present embodiment, the program can be recorded in a computer-readable recording medium. The computer-readable recording medium includes non-transitory computer-readable media, and is, for example, magnetic recording devices, semiconductor memory, and the like. Distribution of the program is carried out by, for example, selling, transferring, or leasing a portable recording medium such as a digital versatile disc (DVD) or the like in which the program is recorded. Also, the program may be distributed by storing the program in storage of an external server and transmitting the program from the external server to another computer. Further, the program may be provided as a program product. Part or all of the functions of the information processing device 10 or the terminal device 20 may be realized by a dedicated circuit corresponding to the control unit 11 or the control unit 21. That is to say, part or all of the functions of the information processing device 10 or the terminal device 20 may be realized by hardware.

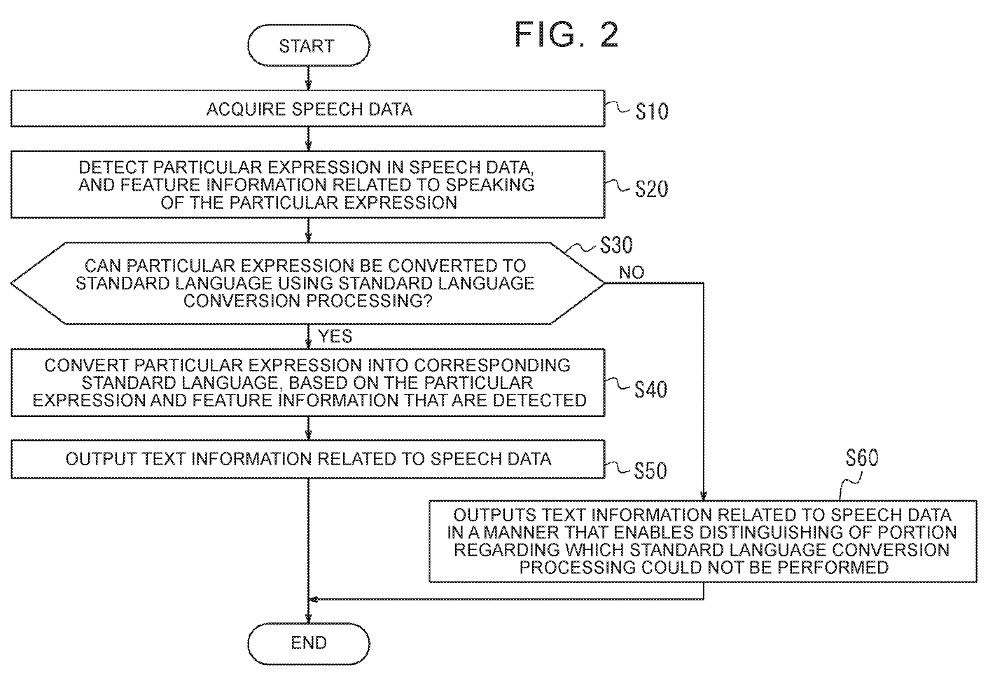

The operations of the information processing device 10 according to the present embodiment will be described with reference to FIG. 2. Here, an example in which the business negotiations are related to vehicle sales will be primarily described. First, the control unit 11 of the information processing device 10 acquires speech data (step S10). Any technique can be employed for acquisition processing of the speech data. For example, the control unit 11 may acquire speech data from an external device or the like including the terminal device 20 via the communication unit 15 and the network 30. Also, the control unit 11 may acquire speech data via the input unit 13, for example.

Next, the control unit 11 detects a particular expression in the speech data acquired in step S10, and feature information related to speaking of the particular expression (step S20). Particular expressions include certain expressions that are used in actual speech, such as dialects, non-standard language, slang, and so forth. Any technique can be employed for the processing of detecting particular expressions in speech data. For example, a technique may be employed in which keywords, phrases, and so forth, which are registered in advance as particular expressions are matched using a speech recognition engine. Also, for example, a technique may be employed in which a machine learning model, such as deep learning or the like, is used to classify speaking patterns and identify predetermined expressions. The feature information related to the speaking of a particular expression includes, for example, tone information related to the utterance of a particular expression, pronunciation rhythm, pitch variations, and speaking speed. Such feature information often reflects vocal traits, emotions, and intentions of the speaker, and is considered important for capturing in detail how a particular expression was pronounced. Any technique can be employed for the processing of detecting feature information related to the speaking of a particular expression. For example, a technique may be employed that uses a pitch detection algorithm to analyze tonal variations. Also, for example, a technique may be employed in which the time and frequency features of speech signals are extracted using spectrogram analysis or the like. Furthermore, for example, feature information that is related to speech may be detected by comprehensively grasping features of speaking, utilizing a machine learning model such as deep learning or the like.

Next, the control unit 11 determines whether standard language conversion processing for converting a particular expression into corresponding standard language can be performed, based on the particular expression and the feature information that are detected (step S30). Any technique may be employed for this determination processing. For example, an assumption will be made that the standard language conversion processing is processing of converting a particular expression into standard language based on a pair of a particular expression and feature information that is detected, and a conversion rule between non-standard language and standard language. In this case, in a case in which the conversion rule contains the pair of the particular expression and the feature information, the control unit 11 determines that standard language conversion processing can be performed. On the other hand, when the conversion rule does not contain this pair of the particular expression and the feature information, the control unit 11 determines that standard language conversion processing cannot be performed.

When determination is made in step S30 that standard language conversion processing can be performed, the control unit 11 converts the particular expression into the corresponding standard language, based on the particular expression and the feature information that are detected (step S40). Any technique may be employed for the conversion processing into standard language. For example, the control unit 11 may perform processing of converting a particular expression into standard language based on a pair of the particular expression and the feature information that is detected, and a conversion rule between non-standard language and standard language. The conversion rule may be stored in the storage unit 12, for example, and the control unit 11 may execute the above conversion processing by referring to the conversion rule in the storage unit 12. Note that in this case, the conversion rule may be a conversion table for conversion between pairs of particular expressions and feature information, and corresponding standard language. The corresponding standard language is the standard language to which each of the particular expressions should be converted. In other words, the corresponding standard language is a linguistic expression that is obtained as a result of the conversion processing. Alternatively, the control unit 11 may execute conversion processing to standard language using a machine learning model that executes standard language conversion processing based on the particular expression and the feature information that are detected.

Following step S40, the control unit 11 outputs text information related to the speech data (step S50). The text information is information that is obtained by converting speech data into text, and is information that is obtained by converting above-described particular expressions in the speech data into standard language. In other words, the text information that is output is a sentence in standard language obtained as a result of speech recognition, and is text that has undergone processing for detecting particular expressions and performing conversion thereof into standard language. For example, for speech data including the British phrase "This road is nixed", the control unit 11 outputs text information "This road is closed" using the particular expression "nixed" and conversion rules based on tone. In this way, even when a particular expression is a dialect, phrase, or the like used in a different region or culture, it can be converted into standard language by using appropriate conversion rules, and the text information is provided in a manner that can be understood by a wider range of users. Any technique can be employed for the output processing of the text information. For example, the control unit 11 may transmit data to the terminal device 20 via the communication unit 15, and output determination results via a user interface that is displayed and output by the output unit 24 of the terminal device 20. Alternatively, the control unit 11 may output the determination results via a user interface that is displayed and output by the output unit 14.

When determination is made in step S30 that standard language conversion processing cannot be performed, the control unit 11 outputs text information related to the speech data in a manner in which the portion regarding which the standard language conversion processing could not be performed is distinguishable (step S60). Any technique can be employed for the output processing of this text information. For example, the control unit 11 may transmit data to the terminal device 20 via the communication unit 15, and output determination results via the user interface that is displayed and output by the output unit 24 of the terminal device 20. Alternatively, the control unit 11 may output the determination results via the user interface that is displayed and output by the output unit 14. The manner in which the portion regarding which standard language conversion processing could not be performed is distinguishable includes, for example, a manner of highlighting the particular expression regarding which the standard language conversion processing could not be performed, underlining it, or the like.

According to this configuration, the information processing device 10 detects particular expressions in the speech data and the feature information related to speaking of the particular expressions, and when standard language conversion processing is unsuccessful, outputs text information related to the speech data in a manner that enables distinguishing of the portion regarding which the standard language conversion processing was unsuccessful. Accordingly, when a particular expression is inconvertible, text information is output in a manner that makes the relevant portion distinguishable, thereby improving text conversion technology for speech data, in that unsuccessful conversion into standard language can be readily comprehended.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions and so forth included in the configurations, steps, etc. can be rearranged so as not to be logically inconsistent, and a plurality of configurations, steps, etc. can be combined into one or divided.

For example, the control unit 11 of the information processing device 10 may execute annotation processing for a particular expression that could not be converted into standard language. Any technique can be employed for the annotation processing. For example, the control unit 11 may receive user input and execute manual annotation processing for a particular expression. Also, for example, the control unit 11 may automatically execute annotation processing by inputting a particular expression that could not be converted into standard language into a Large Language Model (LLM) or the like, and estimating a standard language for this particular expression. This allows the particular expression to be modified based on the annotation, and text information related to the speech data may be saved, stored, or the like. The control unit 11 may also update the conversion rule based on the annotation processing and store the updated conversion rule in the storage unit 12. Alternatively, the control unit 11 may re-train the machine learning model related to the standard language conversion processing, based on the annotation processing.

Also, for example, in the above embodiment, an embodiment can be made in which the configuration and operations of the information processing device 10 are distributed among a plurality of computers capable of communicating with each other.

What is claimed is:

1. A conversion method of speech data into text, executed by an information processing device, the conversion method comprising:
acquiring speech data;
detecting a particular expression in the speech data, and feature information related to speaking of the particular expression; and
outputting text information related to the speech data in a manner that enables distinguishing of a portion regarding which standard language conversion processing is not performable, when the standard language conversion processing to convert the particular expression into corresponding standard language based on the particular expression and the feature information that are detected is not performable.

2. The conversion method according to claim 1, wherein the standard language conversion processing is processing of converting the particular expression into standard language, based on a pair of the particular expression and the feature information that is detected, and a conversion rule between non-standard language and standard language.

3. The conversion method according to claim 1, wherein the feature information relating to the speaking is tone information.

4. The conversion method according to claim 1, wherein the particular expression includes dialect and non-standard language.

5. The conversion method according to claim 1, further comprising executing annotation for a particular expression regarding which conversion to standard language was not performable.
